(19) United States
(12) Patent Application Publication
(10) Pub. No.: US 2013/0060634 A1
(43) Pub. Date: Mar. 7, 2013

(54) METHODS AND APPARATUS FOR SELECTING ADVERTISEMENTS

(71) Applicants: Mathew Scott Corson, Gillette, NJ (US); Vincent D. Park, Budd Lake, NJ (US); Arthur Stephens, Hazlet, NJ (US); Ranjith S. Jayaram, Cupertino, CA (US); Georgios Tsirtsis, London (GB); Charles Cullen Childress, Austin, TX (US)

(72) Inventors: Mathew Scott Corson, Gillette, NJ (US); Vincent D. Park, Budd Lake, NJ (US); Arthur Stephens, Hazlet, NJ (US); Ranjith S. Jayaram, Cupertino, CA (US); Georgios Tsirtsis, London (GB); Charles Cullen Childress, Austin, TX (US)

(73) Assignee: QUALCOMM Incorporated, San Diego, CA (US)

(21) Appl. No.: 13/226,715

(22) Filed: Sep. 7, 2011

(51) Int. Cl. G06Q 30/00

(52) U.S. Cl. 705/14.58; 705/14.4

(57) ABSTRACT

Methods and apparatus related to selecting advertisements for presentation based on, e.g., received signals from devices in the proximity to a user's communications device, are described. In various embodiments a mobile device monitors for signals, e.g., peer discovery or other signals, from other devices which transmit, e.g., broadcast, advertisement related information. In various embodiments a device receives advertising information from an advertising device, e.g., AdPoint. In the case of peer to peer signaling, the AdPoint may be in close proximity to the user device receiving the advertising information. Advertising information received from devices in proximity to the user device are used in selecting an advertisement for presentation. Distance from the user device to the AdPoint transmitting an advertisement or advertisement identifier, distance to a store to which an advertisement relates, and/or distance to a location to which an advertisement relates, are taken into consideration when selecting an advertisement for presentation.

### FIELD

Various embodiments relate to selection of advertisements for presentation, and more particularly, to methods and apparatus for selecting and presenting relevant advertisements to a user of a communications device.

### BACKGROUND

The ability to select advertisements for presentation which are most relevant to a viewer plays an important role in the success of an advertising campaign and in the sales resulting from such an advertising campaign. If a non-relevant advertisement is selected for presentation to the viewer, most likely it will not attract the attention of the viewer and hence will be ignored thereby wasting an advertisement presentation opportunity.

When advertisements are to be presented on a communications device, e.g., to a user of the communications device, it is desirable that ads that are highly relevant to the user be displayed. The local area in which the device and the corresponding user of the device is present, can significantly impact an advertisement's relevance at a particular point in time. For example, an ad for a restaurant may be very relevant when the user is immediately outside a particular restaurant but far less relevant when the user is several blocks away from the restaurant.

In view of the above discussion, it should be appreciated that there is a need for improved advertisement selection methods and apparatus which take into consideration information about proximity to a store, location, and/or a device associated with an advertisement that may be presented, when selecting an advertisement and/or determining an advertisement's relevance at a particular point in time.

### SUMMARY

Methods and apparatus related to selecting one or more advertisements for presentation to a communications device's user based on, e.g., received signals from devices in the proximity of the communications device, are described.

In various embodiments a mobile device monitors for signals, e.g., peer discovery signals, from other devices which transmit, e.g., broadcast, advertisement related information. The devices transmitting advertisement information may, and in some embodiments do, include mobile devices as well as fixed devices.

Devices located at various locations may broadcast advertisement related information. Devices broadcasting advertisement information may be located at a different location than a location to which an advertisement relates. However, in many embodiments devices transmitting advertisement information are located in close proximity to, or in the store or outlet to which the advertisement information being broadcast corresponds. In various embodiments a device, e.g., user device such as a cell phone, personal data assistant (PDA) or other device, receives advertising information from an advertising device, sometimes referred to as an AdPoint. In the case of peer to peer signaling, the AdPoint may be in close proximity to the user device receiving the advertising information, e.g., within one thousand meters or even within a few hundred feet, e.g., 100 meters or roughly 300 feet in some embodiments, of the AdPoint transmitting the advertising information. In various embodiments, advertising information received from devices in proximity to the user device are used in selecting an advertisement for presentation. Distance from the user device to the AdPoint transmitting an advertisement, advertiser identifier and/or advertisement identifier, distance from the user device to a store to which an advertisement relates, and/or distance from the user device to a location to which an advertisement relates, are taken into consideration in some embodiments when selecting an advertisement for presentation. Distance, in some embodiments, is measured based on the expected path a user of the device would travel to get to the store or location to which an advertisement relates. While in some embodiments, proximity, e.g., distance, from a location or store to the user device is determined relatively precisely and may involve use of a map and/or path information, in some embodiments proximity is coarsely determined, e.g., with device determining if they are near or far from a store or location, e.g., based on some threshold such as a signal strength threshold or some other proximity metric.

An exemplary method of operating a communications device capable of presenting advertisements, in accordance with some embodiments, comprises: receiving a wireless signal communicating ad information from a local device, said local device being in the proximity of the communications device; and selecting an advertisement for presentation as a function of ad information communicated by the received wireless signal. In some embodiments the ad information is a store or brand identifier. In some embodiments the ad information is associated in a predetermined manner with one or more advertisements corresponding to the store or brand identifier.

An exemplary communications device capable of presenting advertisements, in accordance with some embodiments, comprises: at least one processor configured to: receive a wireless signal communicating ad information from a local device, said local device being in the proximity of the communications device; and select an advertisement for presentation as a function of ad information communicated by the received wireless signal. The exemplary communications device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary system, in accordance with an exemplary embodiment.

FIG. 2 is a flowchart of an exemplary method of operating a communications device capable of presenting advertisements, in accordance with an exemplary embodiment.

FIG. 3 illustrates an exemplary communications device capable of presenting advertisement, in accordance with an exemplary embodiment.

FIG. 4 is an assembly of modules which may be used in the exemplary communications device of FIG. 3.

FIG. 5 illustrates an example where a communications device detects wireless signals communicating ad information from different AdPoints located in a mall and performs advertisement selection in accordance with one embodiment.

### DETAILED DESCRIPTION

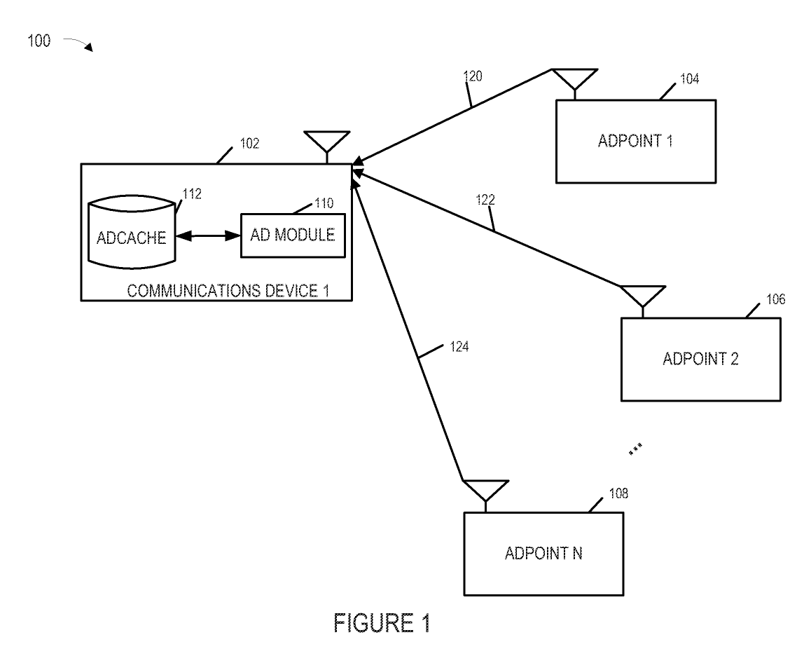

FIG. 1 is a drawing of an exemplary system 100, e.g., a system including communications devices, in accordance with some exemplary embodiments. Exemplary system 100 includes one or more communications devices such as device 1 102 capable of presenting advertisements, and one or more other devices called AdPoints including AdPoint 1 104, AdPoint 2 106, . . . , and AdPoint N 108. The AdPoints (AdPoint 1 104, AdPoint 2 106, . . . , and AdPoint N 108) transmit advertisement related information and in some embodiments the AdPoints are located in the local proximity of the communications device 1 102. Communications device 1 102 in many embodiments is a mobile device, e.g., a handheld mobile device. In some other embodiments the communications device 1 102 is a stationary device. Although not shown in FIG. 1, it should be appreciated that more than one communications device capable of presenting advertisements may be present in the system 100.

The communications device 1 102 includes an ad module 110 and an ad cache 112. The communications device 1 102 in various embodiments is capable of receiving signals both wirelessly and using a wired connection. The communications device 1 102 supports peer to peer signaling protocol in addition to other wireless signaling protocols. Communications device 1 102 can transmit and receive signals, e.g., peer discovery signals and/or traffic data signals, to/from one or more of other devices in the system. The ad cache 112 includes a plurality of stored advertisements and metadata associated with those advertisements. The advertisements may be presented, e.g., displayed, to the user of communications device 102 at some point in time, at a presentation opportunity.

The AdPoints (AdPoint 1 104, AdPoint 2 106, . . . , and AdPoint N 108) transmit, e.g., broadcast, wireless signals (shown using arrows 120, 122, 124) communicating ad information, to communications devices. In some embodiments the wireless signals 120, 122, 124 are peer discovery signals including the ad information. Communications device 1 102 receives the wireless signals from one or more AdPoints in the proximity, e.g., direct wireless communications range, of the communications device 1 102. Proximity in some embodiments may refer to direct peer to peer communications range of two devices. In some embodiments devices are in proximity when they are under a few hundred meters of each other.

In some embodiments the AdPoints (AdPoint 1 104, AdPoint 2 106, . . . , and AdPoint N 108) may transmit different ad information at different points in time. For example ad information transmitted during a period of time corresponding to a lunch time may be, and in some embodiments is, different than ad information transmitted from the same device and location at a different point in time, e.g., during a period of time corresponding to dinner time.

In various embodiments the ad information includes at least one of: an advertisement identifier, store identifier, advertiser identifier, brand identifier, or advertisement related control information, corresponding to a plurality of advertisements stored in the ad cache of communications devices in the system 100 including the device 1 102. The advertisement identifier may be used to identify an advertisement which can be retrieved from advertisement store, e.g., storage device including advertisements, or from another source of advertisements such as an advertisement broadcast channel or a remote ad server. In accordance with one aspect of various embodiments, the communications device 1 102 receiving the ad information uses the ad information in selecting one or more relevant advertisements for presentation to the user of the communications device at a presentation opportunity. In various embodiments, the ad module 110 that has access to the advertisements stored in ad cache 112, is responsible for selecting advertisements as a function of the received ad information. In various embodiments the ad cache 112 includes a set of ad metadata associated with one or more advertisements. The ad metadata may identify an advertisement, an advertiser of the advertisement, targeting parameters, historic performance of the advertisement, etc. Different ad metadata may correspond to, and be communicated by an AdPoint, for each of a plurality of different advertisements for which information is transmitted by an AdPoint.

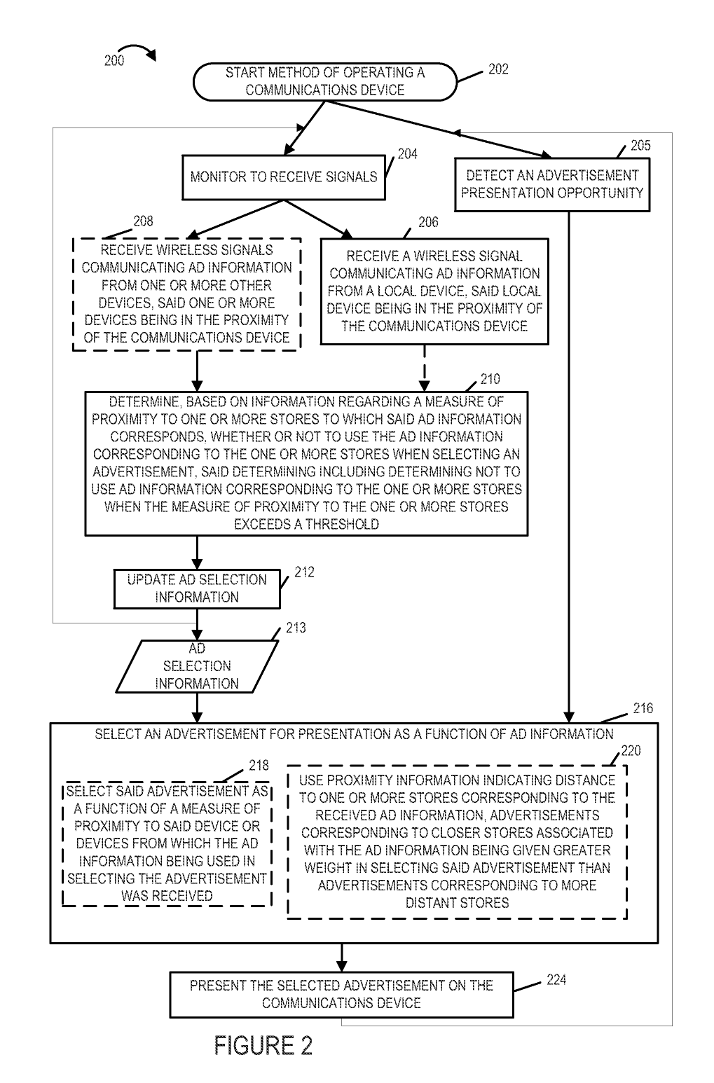

FIG. 2 is a flowchart 200 of an exemplary method of operating a communications device capable of presenting advertisements, in accordance with an exemplary embodiment. The method of flowchart 200 can be, and in some embodiments is, implemented by the communications device 1 102 of system 100 of FIG. 1. As will be discussed, in accordance with one feature of various embodiments, the communications device 1 102 receives wireless signal(s) from one or more devices, e.g., AdPoints, which transmit ad information and are in the vicinity of the communications device 1 102. In accordance with one aspect of various embodiments, the communications device 1 102 selects an advertisement for presentation as a function of the ad information included in the received ad information.

The method shown in FIG. 2 starts in step 202, with the communications device 1 102 being powered on and initialized. Operation proceeds from start step 202 to steps 204 and 205 which are performed asynchronously in some embodiments.

In step 204 the communications device 1 102 starts monitoring to detect and/or receive signals, e.g., wireless signals transmitted from other devices in the system 100.

Operation proceeds from step 204 to step 206. In step 206 the communications device 1 102 receives a wireless signal from a local device which transmits ad information, said local device being in the proximity (e.g., direct wireless communications range) of the communications device 1 102. In accordance with one feature various devices in the local proximity, e.g., the AdPoints 104, 106, 108, transmit wireless signals communicating ad information so that communications devices capable of presenting advertisements can detect the signals and select relevant advertisements for presentation at a presentation opportunity. For the sake of discussion consider that the local device from which the wireless signal is received is AdPoint 1 104.

In some embodiments in addition to receiving wireless signal from the local device, e.g., AdPoint 1 104, the communications device 1 102 receives wireless signals from one or more other devices in the local proximity of the communications device 1 102. This is illustrated in the optional step 208. Thus in such embodiments the operation proceeds from step 204 to steps 206 and 208 simultaneously, and the steps 206 and 208 may be performed asynchronously in parallel. For example, the communications device 1 102 may receive wireless signal 120 from AdPoint 1 104 in step 206, and in step 208 the communications device 1 102 may also receive wireless signals communicating ad information from one or more other devices, e.g., AdPoints 106, 108, said one or more devices being in the proximity of the communications device 1 102. In some embodiments the ad information communicates a store or brand identifier. In some embodiments a plurality of advertisements are stored in the ad cache 112 of the communications device 1 102, and the ad information is associated in a predetermined manner with one or more advertisements corresponding to a store or brand identifier communicated by said ad information.

In one embodiment the ad information includes at least one advertisement corresponding to a store or a brand, along with an advertisement identifier (advertisement ID) identifying the advertisement. In various embodiments the ad information includes an advertisement ID identifying an advertisement stored in the ad cache 112. Thus using received ad information, corresponding advertisements stored in the ad cache 112 can be identified.

In some embodiments the ad information transmitted by a single AdPoint corresponds to a plurality of advertisements. Thus the ad information may include advertisement IDs corresponding to a plurality of advertisements corresponding to, e.g., different stores. In some embodiments the ad information is associated in a predetermined manner with one or more advertisements corresponding to a store or brand identifier communicated by said ad information. In some embodiments the ad information is associated with advertisements corresponding to one or more stores. In some embodiments the ad information further includes information corresponding to one or more stores. In some such embodiments said information corresponding to the one or more stores indicates individual distances to the one or more stores from the AdPoint transmitting the ad information, e.g., from AdPoint 1 104. The communications device 1 102 receiving the wireless signal communicating the ad information can determine proximity e.g., distance, to the transmitting AdPoint 1 104 using, e.g., received wireless signal power level. In some embodiments a proximity may be determined to be within one of a variety of categories, e.g., near or far, based on one or more thresholds. For example, received signal strength above a first level may indicate that the communications device is “near” an AdPoint from which a signal was received while a received signals power level at or below the threshold may indicate that the receiving device is “far” from the AdPoint 1 104 transmitting the signal. Thus signal strength serves as a proximity metric, e.g., indicator of distance, in some embodiments.

While a course proximity determination is suitable for many embodiments, a detailed distance determination is made in some embodiments. In some but not all embodiments, an actual distance to an AdPoint is determined. Using the determined distance to the AdPoint 1 104 that transmitted the ad information, in combination with the received information indicating individual distances to the one or more stores from the AdPoint 1 104, and/or map information such as a mall map, the communication device 1 102 can estimate the individual distances to the one or more stores to which the ad information corresponds with respect to the communication device's location. However, it should be appreciated that the proximity to the AdPoints transmitting the ad information and/or the distance to the one or more stores to which the ad information corresponds can be determined in a variety of other ways. It should be appreciated that the receiving device 1 102 can get a measure of how proximate the transmitting device is by using, e.g., the receiving signal power level and/or other signal characteristics such as signal transmission delay and/or delay spread. The AdPoints transmitting the ad information may be, and in some embodiments are, located at the stores to which the ad information corresponds.

Operation proceeds from step 206 and optional step 208 to step 210. In step 210 the communications device 1 102 determines, based on information regarding proximity to, e.g., distance to, one or more stores to which the received ad information corresponds, whether or not to use the ad information corresponding to the one or more stores, when selecting an advertisement for presentation, the step of determining including determining not to use the ad information (e.g., advertisement IDs, store or brand identifiers) corresponding to the one or more stores when the measure of proximity, e.g., distance, to the one or more stores exceeds a threshold. In some embodiments the threshold is e.g., a predetermined distance. Thus it should be appreciated that in some embodiments the communications device 1 102 excludes, from an advertisement selection process, the advertisements corresponding to one or more stores which are relatively far away from the communications device 1 102 at the given time. In accordance with one aspect, the advertisements which correspond to stores which are relatively far from the communications device 1 102 may, and in some embodiments are, not considered relevant for presentation to the user of device 1 102.

Operation proceeds from step 210 to step 212. In step 212 the communications device 1 102 updates ad selection information to incorporate the exclusion of advertisements corresponding to one or more stores which are relatively far away from the communications device 1 102 at the given time. The ad selection information update step may be performed by a module which outputs data, i.e., updated ad selection information 213. The ad selection information 213 includes the ad information which has been updated, e.g., to exclude advertisements corresponding to one or more stores which are not considered relevant for presentation at the given, e.g., due to a relatively greater distance of the communications device 1 102 from the one or more stores at the given time and/or other reasons. The ad selection information 213 in some embodiments further includes information that may impact advertisement selection process, e.g., user and/or device context information. Thus, the ad selection information 213 may include a subset of the received ad information from one or more AdPoints, plus additional information which is of relevance in the advertisement selection. The operation proceeds from step 212 back to step 204. The steps 204 through 212 may be performed on an ongoing basis as the communications device 1 102 detects one or more wireless signals from local AdPoints in the proximity.

Returning now to step 205. In step 205 the communications device detects an advertisement presentation opportunity, i.e., an opportunity when an advertisement can be presented to the user of communications device 1 102. In case of an advertisement including an image and/or video and/or text, the presentation opportunity corresponds to a display opportunity. At each presentation opportunity one or more advertisement may be presented. In accordance with one aspect of various embodiments, at each presentation opportunity, advertisements which are deemed more relevant at a given point in time, are selected for presentation to the user of communications device 1 102. One criteria of relevance is the communications device proximity criteria. For example, according to this criterion an ad for a restaurant is considered to be very relevant when the communications device and it's user are physically closer, e.g., immediately outside, a particular store such as a restaurant, but far less relevant when the user is several blocks away from the store. Thus it should be appreciated that it is desirable to select most relevant advertisements at the given time for presentation.

In step 216 the communications device 1 102 selects an advertisement for presentation as a function of the ad information included in the received wireless signal(s). In some embodiments when the communications device receives wireless signals from a plurality of devices in proximity to the communications device 1 102, selecting an advertisement is performed as a function of the ad information from the plurality of these devices. The selection step 216 includes steps 218 and 220, which may be performed in some but not all embodiments and therefore are shown using dashed boxes. In some embodiments the selection of one or more advertisement in step 216 is performed by performing step 218 while in some embodiments by performing step 220. In still some other embodiments, step 216 is implemented by performing both steps 218 and 220.

In step 218, the communications device 1 102 selects the advertisement as a function of a measure of proximity to the device (e.g., AdPoint 1 104) or to individual devices (e.g., AdPoint 2 106, . . . , AdPoint N 108) from which the ad information being used in selecting the advertisement was received. For example, the communications device 1 102 determines the distance to the AdPoint 1 104 and/or individual distances to other AdPoints from which the ad information was received, e.g., based on received signal strength measurement, and selects the advertisement corresponding to the ad information transmitted by the AdPoint 1 104 which is nearest to the communications device 1 102. In some embodiments an AdPoint transmitting the ad information is located at the store identified in the ad information transmitted by the AdPoint. In some other embodiments the AdPoints transmitting the ad information are located at a different location than the stores to which the ad information corresponds.

If the presentation opportunity allows the communications device to present more than one advertisement, the communications device 1 102 may select other advertisements corresponding to the ad information transmitted by the same AdPoint, e.g., AdPoint 1 104, or may select advertisements corresponding to the ad information transmitted by an AdPoint (e.g., AdPoint 2 106) which is the second nearest AdPoint to the communications device 1 102. Thus in some embodiments selecting an advertisement is performed as a function of the proximity to the individual devices from which the ad information is received.

In step 220 the communications device 1 102 uses proximity information indicating distance to one or more stores corresponding to the received ad information in selecting the advertisement, advertisements corresponding to closer stores being given greater weight in selecting said advertisement than advertisements corresponding to more distant stores. Thus in some embodiments the communications device 1 102 determines the distance to the one or more stores (as discussed with regard to step 210) and selects the advertisement corresponding to the store which is nearest to the communications device at the given time. The advertisement corresponding to a given store is identified using the advertisement identifier and/or associated store identifier included in the ad information. Thus it should appreciated that in such embodiments advertisement selection probability is higher for advertisements corresponding to stores which are closer to the communications device 1 102 at the time an advertisement is selected for an ad presentation opportunity, e.g., an opportunity to display or otherwise present an ad via the user's device. As can be appreciated an ad may be presented on the display in the case of an ad including image content and/or via another output device of the user device such as a speaker in the case of an advertisement presented in the form of audio such as a speech based advertisement.

In some embodiments the received ad information, used in selecting one or more advertisements for presentation, includes control information used to control an amount which is bid for presentation of an identified advertisement by the communications device 1 102. In some such embodiments the selection in step 216 is made taking into consideration more than one factor, e.g., i) distance to a store corresponding to an identified advertisement included in the ad information and, ii) an amount of bid placed for presentation of identified advertisement. The control information corresponding to an advertisement controls an amount which is bid for presentation of the identified advertisement. For example, the control information corresponding to an identified advertisement may modify a bid amount, previously set by the advertiser/store, to a new bid value, when one or more conditions are met. In some embodiments the advertisement with the highest bid amount is selected for presentation.

In some embodiments the received ad information, which is used in the advertisement selection process, includes control bits used to control advertisement content which is displayed when an advertisement identified by said ad identifier is selected for display. In some embodiments controlling advertisement content which is displayed for a selected advertisement includes modifying at least some content of the selected advertisement for displaying. For example, the received ad information includes an advertisement ID identifying an advertisement stored in the ad cache 112, and may include control bits associated with the advertisement ID indicating that if the corresponding advertisement is selected at a certain time of the day, e.g., after 7 PM on weekdays, then a portion of the content of the selected advertisement, e.g., a portion of an image, is modified to display the special offers applicable after 7:00 PM at the store to which the advertisement corresponds. The special offer content may include, for example, a special dinner price for a particular meal and may be displayed in a predetermined portion of what may otherwise be a static advertisement. During lunch time periods the same ad may be controlled to display a lunch meal and corresponding price for the same restaurant.

Operation proceeds from step 216 to step 224. In step 224 the selected advertisement is presented on the communications device 1 102 to the user. When the selected advertisement includes an image and/or video, the presentation includes displaying the selected advertisement. The operation proceeds from step 224 back to step 205. The selection step 216 and presentation step 224 are repeated if another presentation opportunity is detected.

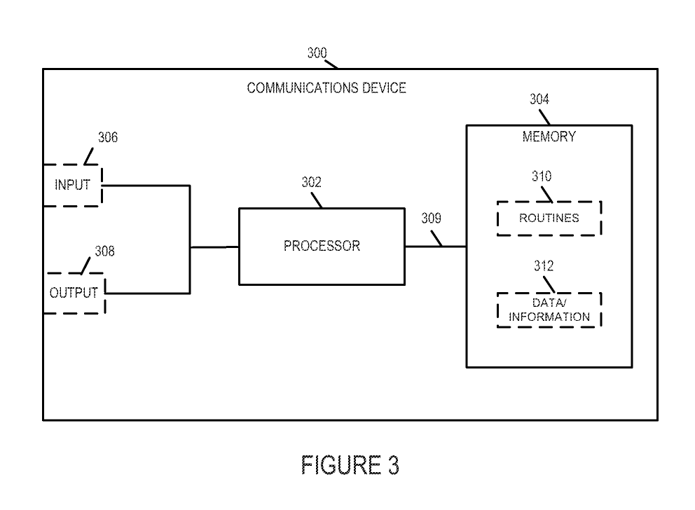

FIG. 3 is a drawing of an exemplary communications device 300 capable of presenting advertisements, in accordance with an exemplary embodiment. Exemplary communications device 300 may be used as the communications device 1 102 of FIG. 1. Exemplary communications device 300 may, and sometimes does, implement a method in accordance with flowchart 200 of FIG. 2. In various embodiments the communications device 300 is a mobile communications device. In some other embodiments the communications device 300 could be a stationary device.

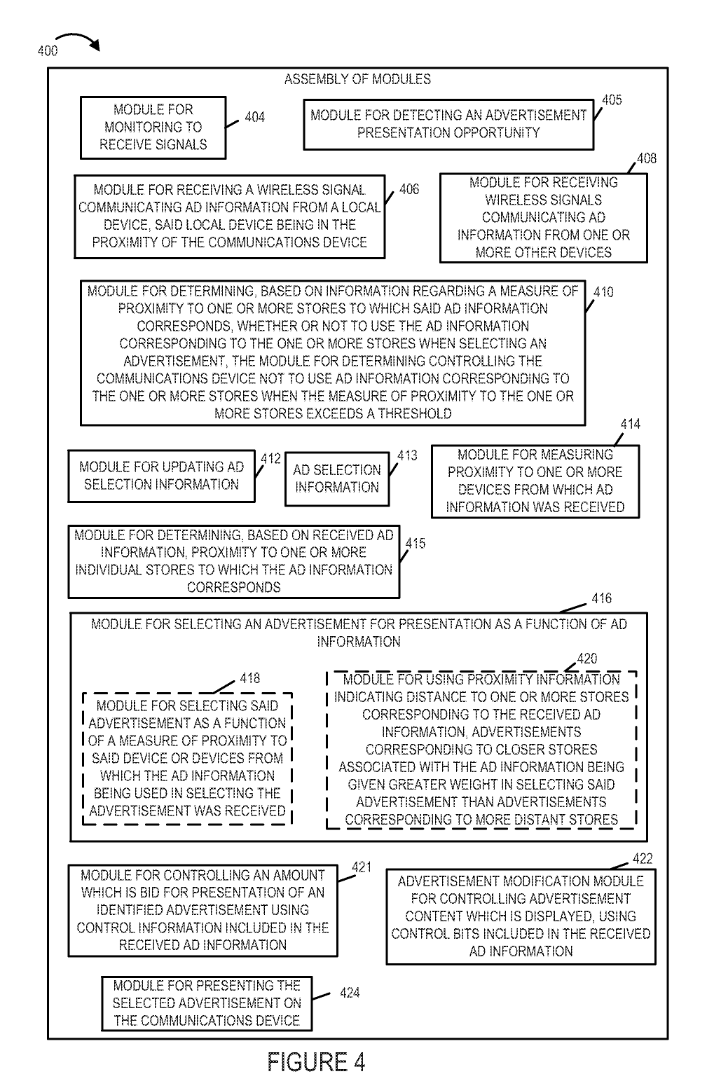

The communications device 300 includes a processor 302 and memory 304 coupled together via a bus 309 over which the various elements (302, 304) may interchange data and information. The memory 304 may include an assembly of modules used to control the communications device 300, e.g., such as the assembly of modules shown in FIG. 4. The communications device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 310 and data/information 312.

Processor 302 is configured to receive a wireless signal communicating ad information from a local device, e.g., an AdPoint, said local device being in the proximity of the communications device 300, and select an advertisement for presentation as a function of ad information included in the received wireless signal. In some embodiments the processor 302 is configured to receive wireless signals communicating ad information from a plurality of devices, e.g., AdPoints, said plurality of devices being in the proximity of the communications device 300. In some embodiments the processor 302 is further configured to select an advertisement for presentation as a function of signals received from a plurality of different devices, e.g., a plurality of AdPoints, in proximity to the communications device 300. In some embodiments the ad information is a store or brand identifier. In some embodiments the ad information is associated in a predetermined manner with one or more advertisements corresponding to the store or brand identifier.

In some embodiments the processor 302 is further configured to determine proximity, e.g., distances, to the individual AdPoints from which the wireless signals are received. In some such embodiments the processor 302 is further configured to select an advertisement as a function of a measure of proximity to the individual devices from which the signals are received.

In some embodiments the ad information includes information corresponding to at least one store. In some such embodiments the processor 302 is further configured to determine, based on information regarding a measure of proximity, e.g., distance, to the at least one store, whether or not to use ad information corresponding to said at least one store when selecting an advertisement for presentation, the processor 302 being further configured to determine not to use said ad information corresponding to said at least one store when the measure of proximity to the at least one store exceeds a threshold. The processor 302 is further configured to update ad selection information, based on the determination that ad information corresponding to at least one store is not to be used in selecting an advertisement when the measure of proximity to the at least one store exceeds a threshold. In some embodiments the processor 302 is further configured to select an advertisement for presentation as a function of the updated ad selection information.

Processor 302, in some embodiments, is further configured to select an advertisement for presentation using proximity distance information indicating distance to one or more stores corresponding to the received ad information, advertisements corresponding to closer stores being given greater weight in selecting said advertisement than advertisements corresponding to more distant stores.

In some embodiments the ad information includes an advertisement identifier. In some embodiments the ad information includes control bits used to control advertisement content which is displayed when an advertisement identified by said ad identifier is selected for display. In some embodiments the ad information includes control information used to control an amount which is bid for presentation of an identified advertisement. In some such embodiments the processor 302 is further configured to select an advertisement for presentation as a function of an amount which is bid for presentation of the identified advertisement. The processor 302 is further configured to present, e.g., display, the selected advertisement to the user of the communications device 300.

FIG. 4 illustrates an assembly of modules 400 which can, and in some embodiments is, used in a communications device such as the communications device 300 illustrated in FIG. 3. The modules in the assembly 400 can be implemented in hardware within the processor 302 of FIG. 3, e.g., as individual circuits. Alternatively, the modules may be implemented in software and stored in the memory 304 of the communications device 300 shown in FIG. 3. In some such embodiments, the assembly of modules 400 is included in routines 310 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the wireless communications device 300 or elements therein such as the processor 302, to perform the functions of the corresponding steps illustrated and/or described in the method of flowchart 200 of FIG. 2.

The assembly of modules 400 includes a module corresponding to each step of the method of flowchart 200 shown in FIG. 2. For example module 404 corresponds to step 204 and is responsible for performing the operation described with regard to step 204. The assembly of modules 400 includes a module 404 for monitoring to receive signals, a module 405 for detecting an advertisement presentation opportunity, a module 406 for receiving a wireless signal communicating ad information from a local device, e.g., AdPoint 1 104, said local device being in the proximity (e.g., direct wireless communications range) of the communications device 300, and a module 408 for receiving wireless signals communicating ad information, from one or more other additional devices, e.g., AdPoints 106, 108.

In some embodiments the ad information is a store or brand identifier. In some embodiments the ad information is associated in a predetermined manner with one or more advertisements corresponding to the store or brand identifier. In some embodiments the ad information transmitted by a single AdPoint corresponds to a plurality of advertisements corresponding to the same or different stores. In some embodiments the ad information further includes information corresponding to one or more stores. In some embodiments, the ad information corresponding to the one or more stores, indicates individual distances to the one or more stores from the AdPoint transmitting the ad information, e.g., from AdPoint 1 104.

The assembly of modules 400 in some embodiments further includes a module 410 for determining, based on information regarding a measure of proximity, e.g., distance, to one or more stores to which the received ad information corresponds, whether or not to use the ad information corresponding to the one or more stores when selecting an advertisement for presentation, the module 410 controlling the communications device 300 not to use the ad information (e.g., advertisement IDs, store or brand identifiers) corresponding to the one or more stores when the measure of proximity to the one or more stores exceeds a threshold. In some embodiments the threshold is e.g., a predetermined distance. Thus in some embodiments the module 410 controls the communications device 1 102 to exclude, from an advertisement selection process, the advertisements corresponding to one or more stores which are relatively far away from the communications device 1 102 at the given time.

The assembly of modules 400 in some embodiments further includes a module 412 for updating ad selection information to exclude one or more advertisements corresponding to the one or more stores which are relatively far away from the communications device 1 102 at the given time. The ad selection information 413, e.g., updated ad information to be used for selecting an advertisement, is the output of the module 412.

In some embodiments assembly of modules 400 further includes a module 414 for measuring proximity, e.g., distance, to one or more devices, e.g., AdPoints, from which ad information is received. The measure of proximity to one or more devices is determined in some embodiments using, e.g., received wireless signal power level. In some embodiments the assembly of module 400 further includes a module 415 for determining, based on the received ad information, proximity to the one or more individual stores to which the ad information corresponds.

In various embodiments the assembly of modules 400 includes a module 416 for selecting an advertisement for presentation as a function of ad information. In some embodiments the selection module 416 selects an advertisement for presentation as a function of ad information received from one device or from a plurality of different devices in proximity to the communications device 300. In some embodiments the selection module 416 includes a module 418 for selecting an advertisement as a function of a measure of proximity to the device or devices from which the ad information being used in selecting the advertisement was received. The measured proximity to the device or devices from which the ad information was received, is the output of module 414 and is an input to the module 418. In some embodiments the selection module 416 further includes a module 420 for using proximity information indicating a distance to one or more stores corresponding to the received ad information in selecting the advertisement, advertisements corresponding to closer stores being given greater weight by module 420 in selecting the advertisement than advertisements corresponding to more distant stores. The distance to one or more stores, in some embodiments, is obtained from the distance determination module 415 and used by module 420 in making the advertisement selection. In some embodiments the selection module 420 selects the advertisement corresponding to a store which is nearest to the communications device at the given time. The selection module 416 can be, and in some embodiments is, used as the ad module 110 of device 1 102 discussed in FIG. 1.

In some embodiments the received ad information which is used in selecting one or more advertisements for presentation includes control information used to control an amount which is bid for presentation of an identified advertisement by the communications device 1 102. The assembly of module 400 in some embodiments further includes a module 421 for controlling an amount which is bid for presentation of an identified advertisement by the communications device 300 based on control information included in the received ad information. In one embodiment the selection module 416 makes an advertisement selection based on i) distance to a store corresponding to an advertisement to which the ad information corresponds and, ii) an amount which is bid for presentation of the advertisement. In some embodiments the advertisement with the highest bid amount and which corresponds to a store which is relatively closer than other stores is selected for presentation. In some embodiments the advertisement with the highest bid amount is selected for presentation.

In some embodiments the received ad information, which is used in the advertisement selection process, includes control bits used to control ad content which is displayed when an advertisement identified by said ad identifier is selected for display. The assembly of module 400 in some embodiments further includes an advertisement modification module 422 for controlling, e.g., modifying, advertisement content which is displayed when an advertisement identified by an ad identifier is selected for display, using control bits included in the received ad information.

The assembly of modules further includes a module 424 for presenting the selected advertisement on the communications device 300 to the user. When the selected advertisement includes an image and/or video, the module 424 controls the communications device 300 to displaying the content of the selected advertisement.

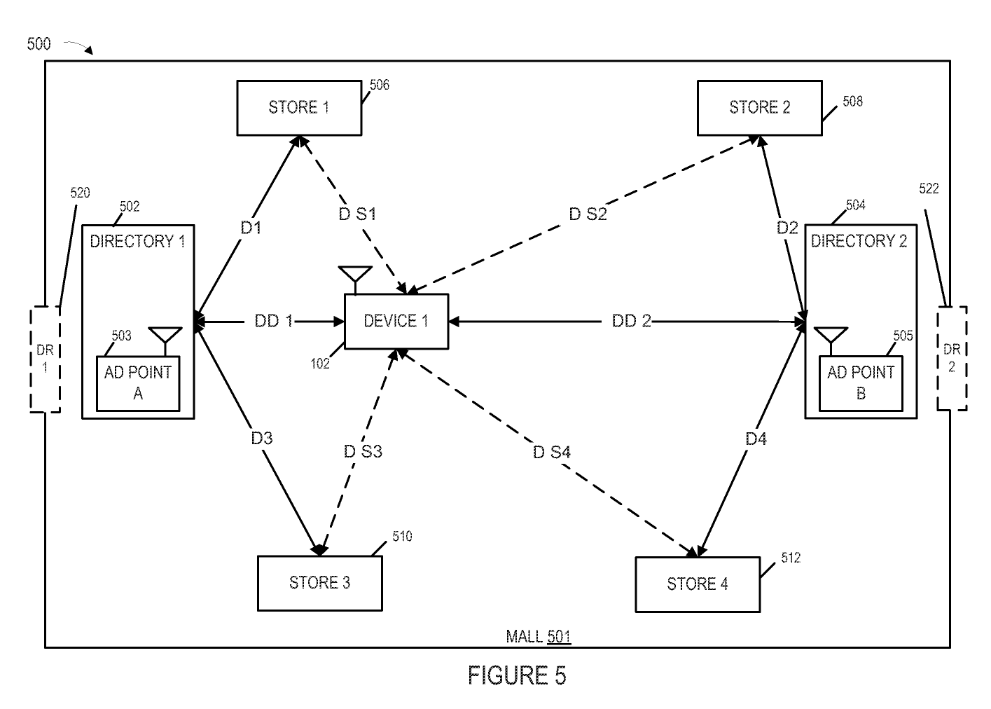

FIG. 5 is a drawing 500 illustrating an example where a communications device, e.g., device 1 102, roams in a mall 501 and detects wireless signals communicating ad information from different AdPoints collocated with the mall directories 502, 504 which are placed at two different entrances to the mall 501. For purposes of explaining various features, the example relates to a mall having the stores and AdPoints located on a single level. As should be appreciated, the methods and apparatus of the invention can be extended to multi-level malls and sites but the proximity and/or distance determination methods in such embodiments may and sometimes do involve knowledge of the 3D structure of the building and/or mall in which the methods are used. In the FIG. 5 example, directory 1 502 is located at one end close to door 1 (DR1) 520, e.g., entrance, of the mall 501 while directory 2 504 is located at the other end of the mall close to door 2 (DR2) 522. AdPoint A 503 is configured to transmit ad information corresponding to a plurality of stores which are located at the same end of the mall 501 as the directory 1 502, e.g., within a certain distance range from the directory 1 502. Thus AdPoint A 503 transmits ad information corresponding to multiple stores including store 1 506 and store 3 510. Similarly, AdPoint B 505 is configured to transmit ad information corresponding to a plurality of stores which are located at the same end of the mall 501 as the directory 2 504. Thus AdPoint B 505 transmits ad information corresponding to multiple stores including store 2 508 and store 4 512.

The transmitted ad information includes, e.g., advertisement IDs associated with advertisements corresponding to stores 506 and 510, store IDs associated with advertisements corresponding to stores 506 and 510, control information which can be used to control an amount bid for presentation of an advertisement corresponding to the stores 506 and 510, etc. In some embodiments the ad information transmitted by AdPoints 503, 505 further includes distance information regarding distances to stores 506, 510 and 508, 512 from the directories 502 and 504 respectively. For example the ad information transmitted by AdPoint A 503 in some embodiments includes information indicating the distance D1 which is the distance between the directory 1 502 and the store 1 506 along a path, and distance D3 which is the distance between the directory 1 502 and the store 3 510 along a path. Similarly the ad information transmitted by AdPoint B 505 in some embodiments includes information indicating the distance D2 which is the distance between the directory 2 504 and the store 2 508 along a path, and distance D4 which is the distance between the directory 2 504 and the store 4 512 along a path.

In the illustrated example, the communications device 1 102 receiving wireless signals communicating ad information from AdPoint A 503 and AdPoint B 505, determines the proximity which may be expressed as a distance or another measure such as received signal strength. For purposes of the example DD1 will be considered to be the distance between the device 1 102 and the directory 1 502 and DD2 the distance between the device 1 102 and the directory 2 504. For example by using received signal power level and/or other techniques proximity, e.g., as indicated by a rough distance metric or actual distance precisely indicating proximity may be determined. Proximity may be based on a vector of signal measurements and/or input from other sensors which supply position related information, e.g., a GPS sensor. Using the information regarding distances DD1, D1 and D3, the communications device 1 102 determines the distance DS1 and DS3 which is the distance between the device 1 102 and the stores 506, 510 respectively. In a similar manner the communications device 1 102 determines the distance DS2 and DS4 which is the distance between the device 1 102 and the stores 508, 512, using the information regarding distances DD2, D2 and D4. It should be appreciated that FIG. 5 example corresponds to a particular point in time, and thus the distance information, which is either communicated in the ad information or is derived/determined using the ad information, applies at that particular point time. As the communications device 1 102 moves, the distance between device 102 and the stores/directories changes.

In accordance with one aspect, the distance information may and in various embodiments is, used in making a selection of one or more relevant advertisements for presentation on the communications device 102, where the advertisements corresponding to the nearby stores are considered more relevant. For example, an advertisement corresponding to a store in the mall is more relevant for presentation to the user of device 1 102 when the user is close to, e.g., outside, the store.

In the example illustrated in FIG. 5, the communications device 1 102 selects an advertisement, for presentation at a presentation opportunity, as a function of the distance of the communications device 1 102 to one of: (i) one or more stores corresponding to the received ad information, advertisements corresponding to closer stores being given greater weight in selecting the advertisement than advertisements corresponding to more distant stores; or (ii) the AdPoints, e.g., AdPoints 503, 505, from which the ad information being used in selecting the advertisement was received. The distance information being used in the advertisement selection is determined based on the received ad information. In some embodiments, in addition to the received ad information, the selection process is also based on one or more other factors that are relevant to the user of the communications device 1 102 such as the user's past viewing habits, preferences, etc.

It should be appreciated from FIG. 5 illustration, at the given time, the communications device 1 102 is physically closer to directory 1 502 and thus to AdPoint 503 than directory 2 504. It can also be seen that at the given time communications device 1 102 is physically closest to store 1 506 compared to any other store. Thus in the example of FIG. 5 communications device 1 102 selects an advertisement corresponding to store 1 506 for presentation.

However as discussed above, in some embodiments, one or more factors in addition to the received ad information, are used in selecting an advertisement for presentation.

In various embodiments a mobile communications device, e.g., communications device 300 of FIG. 3, includes a module corresponding to each of the individual steps and/or operations described with regard to any of the Figures in the present application and/or described in the detailed description of the present application. The modules may, and sometimes are implemented in hardware. In other embodiments, the modules may, and sometimes are, implemented as software modules including processor executable instructions which when executed by the processor of the communications device cause the device to implement the corresponding step or operation. In still other embodiments, some or all of the modules are implemented as a combination of hardware and software.

In various embodiments, one aspect that determines relevance of advertisements which are candidates for presentation to the user of a communications device is the proximal context of the user, e.g., the identities and behavior of entities that are near the user. A communications device, e.g., device 1 102, can detect entities in its physical proximity, learn their identities, and also receive information from them. For example, discovery signals, e.g., peer discovery signals, can be used to accomplish these functions through the use of power-efficient, scalable, peer discovery channels. In some embodiments devices supporting 802.11 protocols can transmit beacons that can be detected by devices within a range allowed as per 802.11 range and that encapsulate information chosen by the beacon transmitter. In some embodiments Bluetooth is commonly used to detect devices that are in close proximity.

Various features are directed to an advertisement selection mechanism, e.g., on a communications device, that is a function of the proximity signals that the communications device receives.

Various embodiments are directed to ad selection based on locally received signals, e.g., discovery signals, transmitted by devices in proximity to a device making advertisement selection for presentation. Advertisement selection may be performed as a function of information, e.g., a stored identifier, communicated by the locally received signal. Received signals may include control information which influences the advertisement selection processes by devices in the local area receiving the signal.

In some embodiments a module on a device, e.g., Ad Module 110 on communications device 1 102, has access to a set of metadata associated with advertisements, is responsible for the advertisement selection and presentation process. In one embodiment this is achieved through an AdCache 112 on the device which caches a set of “ad metadata objects”. In another alternate embodiment, the Ad Module 110 has access to a set of ad metadata objects in a central advertising network. Thus the set of ad metadata in some embodiments is in a central network node. The metadata in some embodiments identify an advertisement, its advertiser, its targeting parameters, its historic performance etc. In addition, it is also possible to determine a bid value for an advertisement, given a set of contexts about a device and the advertisement's metadata. In some embodiments bid determination is accomplished either through multi-dimensional metadata tables or through dynamic, programmatic bid scripts.

The device, e.g., a wireless communications device 102, capable of presenting advertisements, listens to signals from entities, e.g., AdPoints, that are proximate to the device. Examples of such signals include expressions announced via peer discovery signals, 802.11 beacon transmissions, and Bluetooth signals. The proximity signals can be transmitted in a peer-to-peer mode or in an infrastructure mode (e.g., 802.11 infrastructure mode).

In one particular embodiment, the proximity signal is associated with advertisements that may be selected as candidates for presentation if a presentation opportunity were to arise around the time the signal is received. For example, an AdPoint at a store may indicate that the store's advertisement is to be selected by one or more devices that are in proximity of the store, for presentation. One way to associate a proximity signal with an advertisement is to encode the advertisement's ID within the signal. Another way is to run a protocol to resolve the proximity signal into the ID of the advertisement associated with the signal. The protocol to resolve is executed on the communications device receiving the signal.

In another case, the Ad Module included in the communications device receives a single proximity signal including the identifier of a single advertisement. The Ad Module then decides to present this advertisement when a presentation opportunity arises.

It is possible that the communications device making the advertisement selection receives multiple proximity signals indicating different advertisements for selection. In such embodiments, the Ad Module of the communications device ranks the indicated different advertisements when a presentation opportunity arises. Various different mechanisms may be used for advertisement selection including auctions which are sometimes used. In general, while some advertisements participating in an auction may be selected through the use of proximity signals, not all advertisements need be. That is, proximity signals are only one way to determine which advertisements participate in the advertisement auction. Thus in at least one embodiment, one or more candidate advertisement which may be selected for presentation, are not communicated by an AdPoint in the proximity, or may not necessarily correspond to a store and/or a brand which is in proximity to the communications device making the advertisement selection.

In another embodiment, the proximity signals not only identify advertisements to be selected as candidates for presentation, but also encodes information e.g., control bits that influence the advertisement selection process (e.g., auction). The value of the control bits may, and in some embodiments is, determined by the advertiser or the entity announcing, e.g., broadcasting, them (e.g., a store, factory outlet). The control bits can be specific to a campaign/advertisement or can be global signals that are available to a plurality of campaigns/advertisements. In some embodiments the control bits influence at least two aspects of the ad selection process:
1. The bid value for a particular advertisement for a presentation opportunity. For example, control bits corresponding to an advertisement can instruct the advertisement's bid script to increase or decrease the bids placed for the advertisement; and
2. The content of the advertisement. For example, using control bits, a store can modify a portion of an advertisement's image to display the latest deals, offers and/or discounts, at the store.

Adjusting bid values and advertisement content in response to proximity signals allows an advertising system to be very dynamic and respond to changes in a user's proximity context in real-time. It should be appreciated that such real-time adjustments not only target advertisements better but also make the system more efficient because the prices at advertisement auctions are determined based on very timely information. Thus in some embodiments the ad information includes an advertisement ID along with control information which influences at least one of (i) bid value for the advertisement identified by the advertisement ID, (ii) advertisement content for the advertisement identified by the advertisement ID.

The techniques of various embodiments may be implemented using software, hardware and/or a combination of software and hardware. Various embodiments are directed to apparatus, e.g., communications devices capable of presenting advertisements, which may be mobile or stationary devices, mobile nodes including ad caches such as a mobile wireless terminal including an ad cache, stationary devices including ad cache. Various embodiments are also directed to methods, e.g., method of controlling and/or operating communications devices capable of presenting advertisements which may include a mobile node including an ad cache, a fixed node including an ad cache. Various embodiments are also directed to machine, e.g., computer, readable medium, e.g., ROM, RAM, CDs, hard discs, etc., which include machine readable instructions for controlling a machine to implement one or more steps of a method.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal receiving, selecting, storing, determining, processing, and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more above discussed methods.

In some embodiments, the processor or processors, e.g., CPUs, of one or more devices, e.g., communications devices such as mobile wireless terminals and/or stationary communications devices, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., communications device, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer to peer signaling protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a communications device capable of presenting advertisements, the method comprising:
receiving a wireless signal communicating ad information from a local device, said local device being in the proximity of the communications device; and
selecting an advertisement for presentation as a function of ad information communicated by the received wireless signal.

2. The method of claim 1, wherein selecting an advertisement for presentation is performed as a function of ad information received from a plurality of different devices in proximity to the communications device.

3. The method of claim 2, wherein said selecting is also performed as a function of a measure of proximity to the individual devices from which the ad information is received.

4. The method of claim 1, wherein said ad information includes information corresponding to at least one store, the method further comprises:
determining, based on information regarding a measure of proximity to said at least one store, whether or not to use ad information corresponding to said at least one store when selecting an advertisement for presentation, said determining including determining not to use said ad information corresponding to said at least one store when said measure of proximity to said at least one store exceeds a threshold.

5. The method of claim 1, wherein selecting an advertisement for presentation includes:
using proximity information indicating distance to one or more stores corresponding to said received ad information, advertisements corresponding to closer stores being given greater weight in selecting said advertisement than advertisements corresponding to more distant stores.

6. The method of claim 1, wherein said ad information includes at least one of: an advertisement identifier, a store identifier, or an advertiser identifier.

7. The method of claim 6, wherein said ad information includes control information used to control an amount which is bid for presentation of an identified advertisement by the communications device.

8. The method of claim 6, wherein said ad information includes control bits used to control advertisement content which is displayed when an advertisement identified by said ad identifier is selected for display.

9. A communications device capable of presenting advertisements, comprising:
means for receiving a wireless signal communicating ad information from a local device, said local device being in the proximity of the communications device; and
means for selecting an advertisement for presentation as a function of ad information communicated by the received wireless signal.

10. The communications device of claim 9, wherein said means for selecting an advertisement for presentation select said advertisement as a function of ad information received from a plurality of different devices in proximity to the communications device.

11. The communications device of claim 9, wherein the ad information includes information corresponding to at least one store, the communications device further comprises:
means for determining, based on information regarding a measure of proximity to said at least one store, whether or not to use the ad information corresponding to said at least one store when selecting an advertisement for presentation.

12. The communications device of claim 9, wherein said means for selecting an advertisement for presentation includes:
means for using proximity information indicating distance to one or more stores corresponding to said received ad information, advertisements corresponding to closer stores being given greater weight in selecting said advertisement than advertisements corresponding to more distant stores.

13. The communications device of claim 9, wherein said ad information includes at least one of: an advertisement identifier, a store identifier, or an advertiser identifier.

14. The communications device of claim 13, wherein said ad information includes control information used to control an amount which is bid for presentation of an identified advertisement by the communications device.

15. The communications device of claim 13, wherein said ad information includes control bits used to control advertisement content which is displayed when an advertisement identified by said ad identifier is selected for display.

16. A communications device capable of presenting advertisements, comprising:
at least one processor configured to:
receive a wireless signal communicating ad information from a local device, said local device being in the proximity of the communications device; and
select an advertisement for presentation as a function of ad information communicated by the received wireless signal; and
a memory coupled to said at least one processor.

17. The communications device of claim 16, wherein said at least one processor is further configured to select said advertisement for presentation as a function of ad information received from a plurality of different devices in proximity to the communications device.

18. The communications device of claim 16, wherein the ad information includes information corresponding to at least one store; and
wherein said at least one processor is further configured to:
determine, based on information regarding a measure of proximity to said at least one store, whether or not to use the ad information corresponding to said at least one store in selecting an advertisement for presentation, said at least one processor being configured to determine not to use said ad information corresponding to said at least one store when said measure of proximity to said at least one store exceeds a threshold.

19. The communications device of claim 16, wherein said at least one processor is further configured to select an advertisement for presentation using proximity information indicating distance to one or more stores corresponding to said received ad information, advertisements corresponding to closer stores being given greater weight in selecting said advertisement than advertisements corresponding to more distant stores.

20. A computer program product for use in a communications device capable of presenting advertisements, comprising:
non-transitory computer readable medium comprising:
code for causing at least one computer to receive a wireless signal communicating ad information from a local device, said local device being in the proximity of the communications device; and
code for causing the at least one computer to select an advertisement for presentation as a function of ad information communicated by the received wireless signal.
